(19) United States
(12) Patent Application Publication
(10) Pub. No.: US 2011/0024458 A1
(43) Pub. Date: Feb. 3, 2011

(54) WATER COOLER

(76) Inventors: Yasuhisa TANAKA, Osaka (JP); Mitsuo Yokota, Osaka (JP); Sang-Oh Kwon, Yongin-si (KR)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/904,644

(22) Filed: Oct. 14, 2010

(30) Foreign Application Priority Data
May 12, 2008 (JP) 2008-125096

(51) Int. Cl. B67D 7/78; B67D 7/80; B67D 7/82

(52) U.S. Cl. 222/146.6

(57) ABSTRACT

The water cooler A comprises a water cooler body 1, a water storage tank 2 arranged in the water cooler body 1, and a container fitting member 3 detachably fitting a container B arranged on an upper end of the water storage tank 2 so that the water in the container B fitted to the container fitting member 3 can be supplied to the water storage tank 2. The water storage tank 2 is divided into upper and lower water storage parts 2a, 2b by a partition plate 4. The upper and lower water storage parts 2a, 2b partially connect and communicate with each other. A cooling pipe 8 is arranged on the lower water storage part 2b so that the water in the lower water storage part 2b can be cooled. The water in the upper water storage part 2a and the water in the lower water storage part 2b can be taken out separately.

### FIELD OF THE INVENTION

This invention relates to a water cooler for taking out the water in a container arranged in the water cooler in two different conditions, i.e., cooled water and water having a substantially ambient temperature.

### BACKGROUND OF THE INVENTION

Today, the water drawn from deep sea and the water drawn from underground are sold at convenience stores and other retail stores since they contain rich minerals and other components.

The water like this is generally drunk cold or in an uncooled state since the minerals contained in the water are destroyed by heating. A water cooler for holding drinking water in its water storage tank is presented in Patent Document 1 by which the drinking water can be taken out from the water storage tank for drinking when needed.

However, only cooled water can be taken from the water cooler. When a person wants to drink water without cooling, the water needs to be prepared separately, which is troublesome and problematic.

The above-mentioned problem may be solved by providing the water cooler with additional water storage part for holding the uncooled water separately from the water storage part for holding the cooled water. However, when either one of the cooled water or the uncooled water is consumed more than the other, the water which has been consumed less stays in the water storage part for a longer time, which is problematic from a hygiene point of view.

Patent Document

Japanese unexamined patent application publication as PCT application No. 2002-527239.

### SUMMARY OF THE INVENTION

A purpose of the present invention is to provide a water cooler which holds water in a container like a PET bottle in a state of cooled water, which will be referred to as “cooled water” hereinafter, and of substantially uncooled water having the temperature close to the ambient temperature, which will be referred to as “ambient temperature water” hereinafter, so that either one of the cooled water or the ambient temperature water can be taken out for drinking according to personal preference. Moreover, even when either one of the cooled water or the ambient temperature water is consumed more than the other, the water in a water storage tank reduces irrespective of which water is consumed faster, so that the cooled water and the ambient temperature water can be taken out fresh anytime for drinking.

The water cooler according to this invention comprises a water cooler body, a water storage tank arranged in the water cooler body and a container fitting member arranged on an upper end of the water storage tank for detachably fitting the container so that the water in the container can be supplied into the water storage tank wherein the water storage tank is divided into upper and lower water storage parts by a partition plate so that the water in the upper water storage part and the water in the lower water storage part can be taken out separately, in which the upper and lower water storage parts are partially connected and communicated with each other, and the lower water storage part is provided with a cooling device so that the water in the lower water storage part can be cooled.

The water cooler further comprises an ice controlling part arranged to extend downward from an outer peripheral edge part of the partition plate.

The water cooler further comprises an oxygen supplying part arranged in a lower part of the water storage tank to supply oxygen into the water storage tank, and an oxygen holding plate having a cylindrical shape and integrally arranged on a lower surface of the partition plate, in which the part surrounded by the oxygen holding plate and the partition plate is formed to serve as an oxygen space for holding the oxygen supplied from the oxygen supplying part, and an oxygen flow hole connecting the upper and lower water storage parts with each other is formed in the part of the partition plate forming the oxygen space so that the oxygen in the oxygen space can be supplied to the upper water storage part through the oxygen flow hole.

The water cooler further comprises a connecting pipe section arranged in a manner of integrating with the partition plate and vertically penetrating the same, and a partition wall having a cylindrical shape and erected on an upper surface of the partition plate part forming the oxygen space in a state of surrounding the connecting pipe section, in which the water in the container fitted to the container fitting member is supplied into the space surrounded by the partition wall, and an oxygen flow hole is formed in the part of the partition plate surrounded by the partition wall so that the water in the upper water storage part can be taken out through the connecting pipe section.

The water cooler further comprises a discharge member including a discharge part having a bottomed cylindrical shape and arranged on a bottom of the water storage tank in an integrating manner, and a discharge pipe penetrating the bottom of the discharge part, in which the inside of the discharge part is connected to a first faucet by the intermediary of the first connecting pipe and a lower end part of the discharge pipe is connected to the second faucet by the intermediary of the second connecting pipe, and a connecting pipe section integrally provided to the partition plate, communicating with the upper and lower water storage parts, and connected to the discharge pipe of the discharge member at a lower end thereof.

In the water cooler, the container fitting member comprises a supporting part having a bottomed cylindrical shape, and a fitting part arranged in a manner of projecting upward from a bottom of the supporting part for detachably fitting a mouth part of the container, in which a space communicating with the water storage tank is formed in the fitting part, and the inside of the supporting part and the inside of the water storage tank communicate with each other via the space.

The water cooler further comprising a heating device arranged on the second connecting pipe.

### ADVANTAGES OF THE INVENTION

The water cooler of this invention comprises a water cooler body, a water storage tank, and a container fitting member. The water storage tank arranged in the water cooler body is divided into an upper water storage part and a lower water storage part by a partition plate so that the water in the upper water storage part and the water in the lower water storage part can be taken out separately. The upper water storage part and the lower water storage part partially connect and communicate with each other. A cooling device is provided to the lower water storage part so that the water in the lower water storage part can be cooled. The container fitting member arranged on an upper end of the water storage tank to detachably fit the container is structured so that the water in the container can be supplied into the water storage tank. The water held in the container is stored in the water storage tank in a manner that the water is stored in the upper water storage part at the temperature close to the ambient temperature, and the water is stored in the lower water storage part in a cooled state, by which the ambient temperature water and the cooled water can be taken out according to the personal preference.

The upper and lower water storage parts are formed of a single water storage tank, and the upper water storage part and the lower water storage part connect and communicate with each other. Therefore, when the amount of water in one of the water storage parts is reduced, new water is supplied from the outside, so that the water in both of the upper and lower water storage parts is kept fresh.

When the amount of water in the lower water storage part is reduced in particular, the water in the upper water storage part flows into the lower water storage part, so that the water in the upper water storage part kept at the ambient temperature and therefore perishable can actively move into the lower water storage part where the water is kept cool and therefore less perishable. Therefore, the water in the water storage tank can be circulated and kept fresh as a whole at all times.

In the water cooler, when an ice controlling part is arranged on an outer peripheral edge of the partition plate in a manner of extending downward, the ice formed in the lower water storage part is prevented from moving up to the upper water storage part, so that the water can be surely stored at the ambient temperature in the upper water storage part and in the cooled state in the lower water storage part.

Further, the water cooler is provided with an oxygen supplying part arranged in a lower part of the water storage tank to supply oxygen into the water storage tank, and a cylindrical oxygen holding plate arranged on a lower face of the partition plate in an integrating manner. The part surrounded by the oxygen holding plate and the partition plate is formed to serve as an oxygen space for holding the oxygen supplied from the oxygen supplying part. An oxygen flow hole is formed in the partition plate part forming the oxygen space to connect the upper water storage part with the lower water storage part. The oxygen in the oxygen space is supplied to the upper water storage part through this oxygen flow hole. Consequently, the oxygen can be dissolved in the water in the upper and lower water storage parts, and in particular, more oxygen can be dissolved in the water in the lower water storage part.

The water cooler is structured as follows. Namely, the water cooler comprises a connecting pipe section integrally arranged to vertically penetrate the partition plate, and a cylindrical partition wall erected on an upper surface of the partition plate part forming the oxygen space in a state of surrounding the connecting pipe section. Further, the water cooler is structured in a manner that the water in the container fitted to the container fitting member is supplied into the space surrounded by the partition wall, and that an oxygen flow hole is formed in the partition plate surrounded by the partition wall. In addition, the water cooler is structured the water in the upper water storage part can be taken out through the connecting pipe section. When the water cooler is thus structured, the water in the lower water storage part and the water in the upper water storage part are thermally isolated from each other by an oxygen layer held in the oxygen space, so that the water in the upper water storage part may be prevented from being cooled by the water in the lower water storage part. Thus, the water in the upper water storage part can be kept to have the ambient temperature and the water in the lower water storage part can be kept cool without fail.

A discharge member includes a discharge part having a bottomed cylindrical shape and arranged on the bottom of the water storage tank in an integrating manner, and a discharge pipe penetrating the bottom of the discharge part. The inside of the discharge part connects with a first faucet by the intermediary of a first connecting pipe, and a lower end of the discharge pipe connects with a second faucet by the intermediary of a second connecting pipe. The connecting pipe section is integrally arranged in the partition plate to allow the upper and lower water storage parts to communicate with each other. A lower end of the connecting pipe section is connected to the discharge pipe of the discharge member. When the water cooler is provided with the discharge member and the connecting pipe section, the water in the upper and lower water storage parts can be taken out completely separately.

In the water cooler, the container fitting member is provided with the supporting part having a bottomed cylindrical shape and the fitting part arranged in a manner of protruding upward from a bottom of the supporting part and detachably fitted by a mouth part of the container. A space communicating with the water storage tank is formed in the fitting part. Since the inside of the supporting part and the inside of the water storage tank communicate with each other through the space, the water in the container can be stably supplied into the water storage tank.

Further, in the water cooler, when a heating device is arranged on the second connecting pipe, the water stored in the upper water storage part and the water in the connecting pipe section, which have been cooled by the water in the lower water storage part, are heated by the heating device, so that the water taken out from the second faucet is made to have the temperature close to the ambient temperature without fail.

### BRIEF DESCRIPTION OF THE DRAWINGS

The drawings show an embodiment of the water cooler in which:

FIG. 1 is a vertical section showing the water cooler of this invention,

FIG. 2 is a vertical section showing the discharge member,

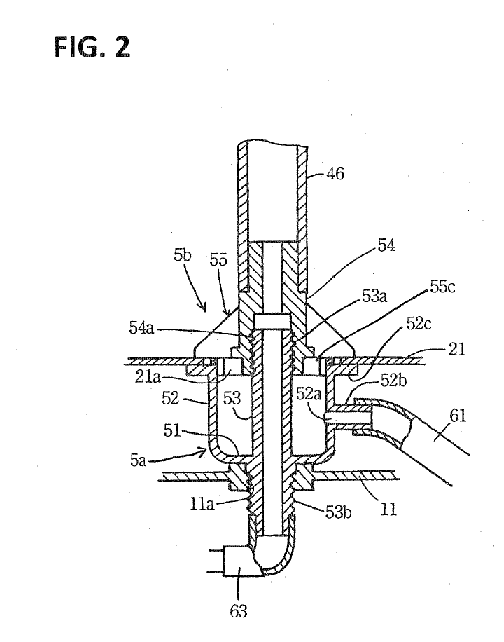

FIG. 3 is an exploded perspective view of the discharge member, and

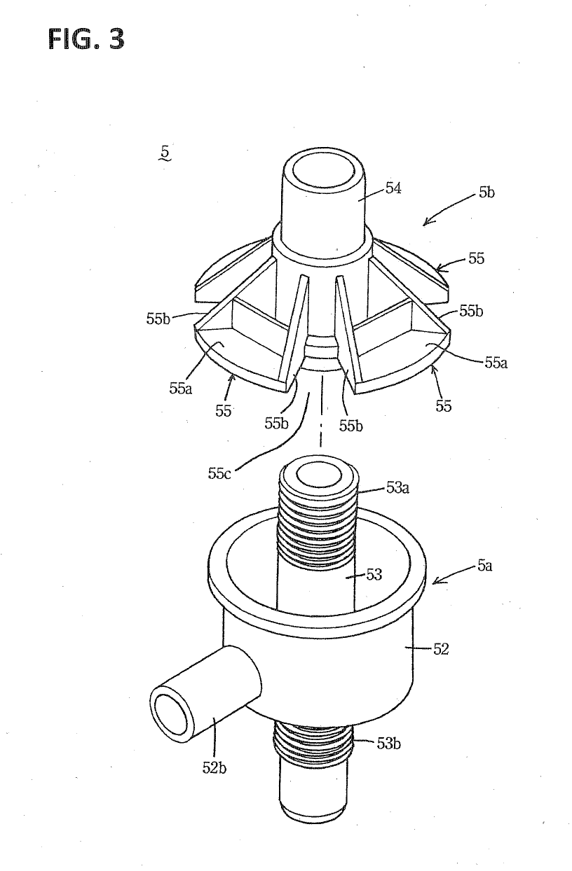

FIG. 4 is a front elevation view showing the water cooler of this invention.

### PREFERRED EMBODIMENT OF THE INVENTION

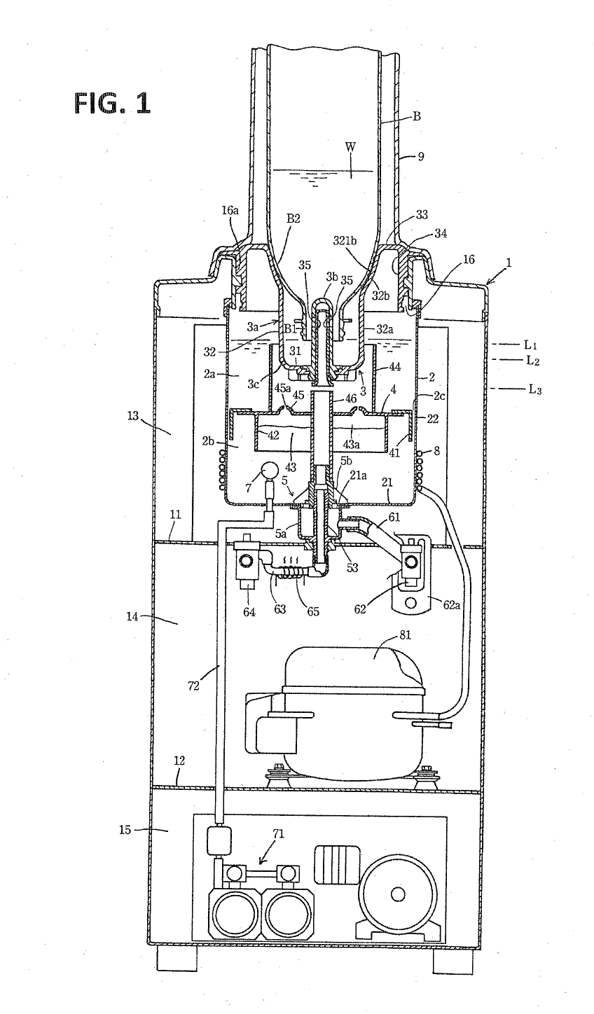

An embodiment of the water cooler A of this invention is explained hereinafter based on the drawings 1 to 4. FIG. 1 shows the state that the inside of a water cooler body 1 is partitioned into three in a vertical direction to form an upper space 13, a central space 14 and a lower space 15 from the top to the bottom by upper and lower placing plates 11, 12.

A water storage tank 2 is arranged in the upper space 13 of the water cooler body 1. The water tank 2 is formed into a bottomed cylindrical shape comprising a flat rectangular bottom 21 and a peripheral wall 22 extending upward from an outer peripheral edge of the bottom 21. An upper end of the water storage tank 1 is fully open.

An opening part 16 is formed in an upper end face of the water cooler body 1. An end part of an upper end opening of the water storage tank 2 is fixed to the water cooler body 1 so that the upper end opening part of the water storage tank 2 may be positioned perpendicularly below the opening part 16.

Further, a container fitting member 3 is arranged in the opening part 16 of the water cooler body 1 in an integrating manner. The container fitting member 3 comprises a supporting part 3a including a bottom part 31 having a flat circular shape and a cylindrical peripheral wall 32 extending upward from an outer peripheral edge of the bottom part 31, and a fitting part 3b provided to the bottom part 31 of the supporting part 3a in an integrating manner. A through hole 3c penetrating through the inner face to the outer face of the supporting part 3a is formed in the part between the bottom part 31 and the peripheral wall 32 of the supporting part 3a which are formed in a continuous manner.

The peripheral wall 32 of the supporting part 3a of the container fitting member 3 comprises a lower-half cylindrical part 32a having a predetermined inner diameter, and a container supporting part 32b continuously formed on an upper end of the cylindrical part 32a to have a mortar-like shape. The container supporting part 32b has an inner diameter which becomes larger in an outer direction as extending upward.

An inner peripheral surface 321b of the container supporting part 32b of the supporting part 3a of the container fitting member 3 is formed to have a curved surface which is bent outward into a circular-arc shape. An upper part B2 of a container B is supported by the inner peripheral surface 321b.

Further, a ring-shaped horizontal part 33 is arranged on a whole periphery of the upper end edge of the peripheral wall 32 of the supporting part 3a of the container fitting member 3. An outside wall 34 is arranged on the whole periphery of an outer peripheral edge of the horizontal part 33 in a manner of extending perpendicularly downward.

The fitting part 3b is integrally arranged on the bottom part 31 of the supporting part 3a of the container fitting member 3. The fitting part 3b is formed into a bottomed cylindrical shape having a closed upper end, a fully opened lower end, and a predetermined length. The lower end of the fitting part 3b protrudes downward from a lower surface of the bottom part 31 of the supporting part 3a and penetrates the bottom part 31 of the supporting part 3a with the closed end up.

Distribution hole parts 35, 35 are formed in an upper end of the fitting part 3b in a state of facing each other in the direction of the diameter of the fitting part 3b and in a manner of penetrating an inner peripheral surface to an outer peripheral surface thereof. The inside and outside of the supporting part 3a communicate with each other through the distribution hole parts 35, 35 and a space in the fitting part 3b.

When the container B like a PET bottle is arranged in the supporting part 3a of the container fitting member 3 with its opening part down, the upper part B2 of the container B is supported by the inner peripheral surface 321b of the container supporting part 32b, and a mouth part B1 of the container B is fitted to the upper end of the fitting part 3b of the container fitting member 3. In this state, the distribution hole parts 35, 35 of the fitting part 3b are positioned in the mouth part B1 of the container B.

By inserting the container fitting member 3 in the opening part 16 of the water cooler body 1 from the above, the container fitting member 3 is fitted and integrated into the opening part 16 of the water cooler body 1 in the state that an outside wall 34 of the supporting part 3a of the container fitting member 3 is in contact with an inner peripheral surface 16a of the opening part 16 of the water cooler body 1.

The supporting part 3a of the container fitting member 3 is in the state that the cylindrical part 32a is positioned in the water storage tank 2 except its upper end part. In the state that the container B is fitted to the container fitting member 3, an opening end, or in other words, a lower end of the mouth part B1 of the container B is positioned lower than an upper end of the water storage tank 2.

A partition plate 4 is arranged in a vertical center part of the inside of the water storage tank 2. The partition plate 4 is formed to have the same shape as that of the bottom 21 of the water storage tank 2 but to be a little smaller than the bottom 21. The inside of the water storage tank 2 is partitioned into upper and lower water storage parts 2a, 2b by this partition plate 4, while a clearance 2c is formed over the whole circumference between an outer peripheral edge of the partition plate 4 and an inner peripheral surface of the water storage tank 2 facing the outer peripheral edge, so that the upper and lower water storage parts 2a, 2b may connect and communicate with each other by the clearance 2c.

A cylindrical ice controlling part 41 is arranged over the whole circumference of the outer peripheral edge of the partition plate 4 in an integrating manner so that the ice controlling part 41 can prevent the ice, which is formed in the lower water storage part 2b, from entering into the upper water storage part 2a.

In addition, an oxygen holding plate 42 having a cylindrical shape and a predetermined height is integrally arranged on a lower face of the outer peripheral edge of the partition plate 4 in a manner of surrounding a connecting pipe section 46, which will be described later. An oxygen space 43 is formed by the oxygen holding plate 42 and part of the partition plate 4 surrounded by the oxygen holding plate 42. The oxygen space 43 holds the oxygen supplied from an oxygen supplying part 7 and forms an oxygen layer 43a.

A partition wall 44 has a cylindrical shape with a predetermined height, and the diameter smaller than that of the oxygen holding plate 42 and larger than that of the cylindrical part 32a of the supporting part 3a of the container fitting member 3. The partition wall 44 is arranged on an upper surface of the partition plate 4 in a manner of protruding upward to surround the connecting pipe section 46, which will be described later. A lower end of the supporting part 3a of the container fitting member 3 is positioned in an upper part of the partition wall 44. In the meantime, the upper end of the partition wall 44 is structured to be positioned lower than the opening end, or in other words, lower than the lower end of the mouth part B1 of the container B fitted to the fitting part 3b of the container fitting member 3.

A plurality of protrusions 45 are formed on the part of the partition plate 4 surrounded by the partition wall 44 by protruding the partition plate 4 upward to form a hemispherical shape. An oxygen flow hole 45a is formed in a top of each of the protrusions 45 in a manner of penetrating through the upper surface to the lower surface so that the oxygen held in the oxygen space 43 can be intermittently supplied to the part above the partition plate 4, or in other words, to the upper water storage part 2a through the oxygen flow hole 45a. In the meantime, the diameter of the oxygen flow hole 45a is 2.5 mm or smaller in general, or preferably 1 to 2 mm.

Further, the connecting pipe section 46 having a predetermined length is integrally arranged in a center part of the partition plate 4 in a manner of vertically penetrating the partition plate 4. The connecting pipe section 46 has a vertically penetrating through hole in it. An upper end opening part of the through hole is positioned at a short distance perpendicularly downward from a lower end opening part of the fitting part 3b of the container fitting member 3. The lower end opening part of the through hole is water-tightly connected to a discharge pipe 53 of a discharge member 5, which will be explained later.

A mounting port 21a is formed in the bottom 21 of the water storage tank 2 through the upper face to the lower face thereof, and the discharge member 5 is integrally mounted on the mounting port 21a. The discharge member 5 is provided with a discharge part 5a and a cover part 5b integrated with the discharge part 5a.

The discharge part 5a is formed into a bottomed cylindrical shape comprising a bottom 51 having a flat circular shape, and a peripheral wall 52 having a predetermined height and extending upward from an outer peripheral edge of the bottom 51. A through hole 52a penetrating through inner to outer peripheral surfaces is formed in the peripheral wall 52. A short connecting pipe 52b is formed on an outside opening end of the through hole 52a to connect a first connecting pipe 61, which will be described later. In the meantime, a flange 52c is arranged on an upper end edge of the peripheral wall 52 of the discharge part 5a in a manner of extending horizontally and outward.

Further, the discharge pipe 53 having a vertically penetrating through hole is formed in the bottom 51 of the discharge part 5a in a manner of vertically penetrating the bottom 51. The discharge pipe 53 is arranged so that a lower end thereof may protrude downward from a lower surface of the bottom 51 of the discharge part 5a, and that an upper end thereof may protrude upward from an upper end opening part of the peripheral wall 52 of the discharge part 5a. Threaded parts 53a, 53b are formed on outer peripheral surfaces of upper and lower ends of the discharge pipe 53, respectively.

The cover part 5b comprises a pipe body 54 having a vertically penetrating through hole in it, and a plurality of holding members 55 formed on the outer peripheral surface of the pipe body 54 at predetermined intervals in the peripheral direction. Each of the holding members 55 comprises a holding element 55a having a flat sector shape and horizontally projecting outward from an outer peripheral surface of a lower end of the pipe body 54, and a plate 55b having a triangular side face connecting both end edges of the holding element 55a and an outer peripheral surface of the pipe body 54. An opening part 55c is formed between the plate 55b and another plate 55b of adjacent holding members 55, 55 in a vertically penetrating manner.

A threaded part 54a which can be threadingly fitted to the upper threaded part 53a of the discharge pipe 53 of the discharge part 5a is formed on an inner peripheral surface of a lower end of the pipe body 54 of the cover part 5b. The cover part 5b is integrated with the upper end of the discharge part 5a by threadingly integrating the threaded part 54a of the pipe body 54 of the cover part 5b with the upper threaded part 53a of the discharge pipe 53 of the discharge part 5a.

A mounting port 21a is formed in the bottom 21 of the water storage tank 2 in a manner of penetrating through the inner to outer faces thereof. The discharge member 5 is integrally mounted on the bottom 21 of the water storage tank 2 by vertically holding an outer peripheral edge of the mounting port 21a of the water storage tank 2 between the flange 52c of the peripheral wall 52 of the discharge part 5a and a holding element 55a of the cover part 5b facing the flange 52c. In the meantime, a packing is arranged between the flange 52c of the peripheral wall 52 of the discharge part 5a and the holding element 55a of the cover part 5b facing the flange 52c.

The lower threaded part 53b of the discharge pipe 53 of the discharge part 5a of the discharge member 5 is inserted into a threaded hole 11a formed in an upper placing plate 11, and is integrally and threadingly fitted to it.

A lower end part of the connecting pipe section 46 of the partition plate 4 is water-tightly fitted to and integrated with an upper end of the pipe body 54 of the discharge member 5. The inside of the upper water storage part 2a and the inside of the discharge pipe 53 of the discharge member 5 connect and communicate with each other by the intermediary of the inside of the connecting pipe section 46 of the partition plate 4 and the inside of the pipe body 54 of the discharge member 5 in the state that they are completely water-tightly partitioned from the lower water storage part 2b.

The inside of the lower water storage part 2b and the inside of the discharge part 5a of the discharge member 5 connect and communicate with each other by the intermediary of an opening part 55c formed between adjacent holding members 55 of the cover part 5b in the state that they are completely water-tightly partitioned from the inside of the connecting pipe section 46 of the partition plate 4, the inside of the discharge pipe 53, and the inside of the pipe body 54 of the discharge member 5.

Furthermore, the inside of the discharge part 5a of the discharge member 5 and a first faucet 62 are connected to each other by connecting an end of the first connecting pipe 61 to the short connecting pipe 52b formed in the peripheral wall 52 of the discharge part 5a of the discharge member 5, and the other end of the first connecting pipe 61 to the first faucet 62. The water in the lower water storage part 2b can be taken out from the first faucet 62 in a freely openable and closeable manner by operating a lever 62a.

In a similar manner, the inside of the discharge pipe 53 of the discharge member 5 and a second faucet 64 are connected to each other by connecting an end of a second connecting pipe 63 to a lower end part of the discharge pipe 53 of the discharge member 5, and the other end of the second connecting pipe 63 to the second faucet 64. The water in the upper water storage part 2a can be taken out from the second faucet 64 in a freely openable and closeable manner by operating a lever 64a.

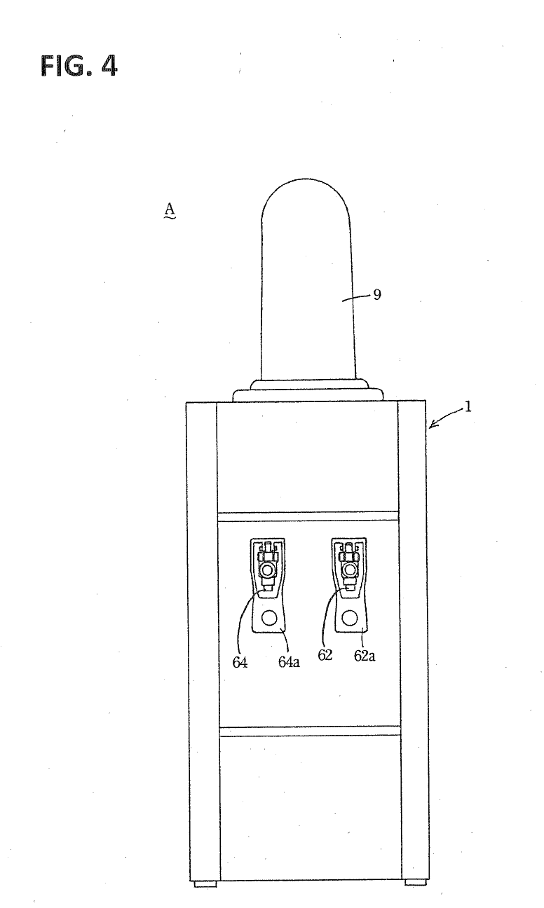

As shown in FIG. 4, the first faucet 62, the second faucet 64, and the levers 62a, 64a are arranged and fixed in a state of being exposed to a front face of the water cooler body 1 by using the upper placing plate 11.

A heating member 65 like a heater is arranged on the second connecting pipe 63 to serve as a heating device so that the water in the second connecting pipe 63 can be heated to a predetermined temperature. The heating member 65 detects the temperature of the water in the second connecting pipe 63. The heating member 65 is controlled by a control device, which is not shown in the drawings, so that electric power may be automatically turned on to heat the water in the second connecting pipe 63 when the temperature of the water falls below the predetermined temperature, and that the electric power may be automatically turned off to stop heating the water in the second connecting pipe 63 when the temperature of the water reaches the predetermined temperature or above.

The oxygen supplying part 7 for supplying oxygen into the water storage tank 2 is integrally arranged in the bottom 21 of the water storage tank 2. The oxygen supplying part 7 is connected to an oxygen generator 71, which removes most nitrogen from the air to obtain oxygen, by the intermediary of a supply pipe 72. The oxygen obtained by the oxygen generator 71 is supplied to the oxygen supplying part 7 through the supply pipe 72, and is supplied into the water storage tank 2 from the oxygen supplying part 7. The oxygen supplying part 7 is adjusted and arranged in the bottom part 21 of the water storage tank 2 so that all the oxygen supplied from the oxygen supplying part 7 may be held in the oxygen space 43 of the partition plate 4. The oxygen generator 71 is arranged in the lower space 15. As for the oxygen generator, an RVSA type oxygen generator which is made available in the market by SANSOTECH Corporation can be used, for example.

All the oxygen supplied from the oxygen supplying part 7 into the water storage tank 2 is held in the oxygen space 43 under the partition plate 4, and the oxygen layer 43a is formed in the oxygen space 43. Part of the oxygen is dissolved in the water in the lower water storage part 2b, and the oxygen in the oxygen space 43 intermittently enters into the upper water storage part 2a through the oxygen flow hole 45a of the partition plate 4. Part of this oxygen entering into the upper water storage part 2a is dissolved in the water there.

A cooling pipe 8 is wound around an outer peripheral surface of the peripheral wall 22, forming the lower water storage part 2b of the water storage tank, a plurality of rounds so that the cooling pipe 8 may cool the water in the lower water storage part 2b. As shown in FIG. 1, a cooling device 81 for supplying and circulating a cooling medium to the cooling pipe 8 is a general purpose one, and is fixed in a central space 14.

Now, how the water cooler A is used is explained. First, the container B like a PET bottle holding potables like water or juice is made ready. Then the container B is arranged in the supporting part 3a of the container fitting member 3 with its opening part down to have the state that the upper part B2 of the container B is supported by the inner peripheral surface 321b of the container supporting part 32b and that the mouth part B1 of the container B is fitted to the upper end of the fitting part 3b of the container fitting member 3. In this state, the distribution hole parts 35, 35 of the fitting part 3b of the container fitting member 3 are positioned in the mouth part B1 of the container B. In the meantime, a clear cover member 9 is removably placed on the container B to prevent dust etc. from entering into the container fitting member 3.

The water W held in the container B is supplied to the water storage tank 2 from the distribution hole parts 35, 35 of the fitting part 3b through the inside of the fitting part 3b, and further through the through hole 3c of the supporting part 3a. In the meantime, the air needs to be supplied into the container B to discharge the water W in the container B. A clearance is formed between the inner peripheral surface 321b of the container supporting part 32b of the container fitting member 3 and the upper part B2 of the container B, and the air flows into the container B through this clearance. The air flows into the container B also from the distribution hole part 35 through the inside of the fitting part 3b until the water in the water storage tank 2 reaches a water level L₃ shown in FIG. 1.

When the water in the container B is gradually supplied into the water storage tank 2 and the water level inside the water storage tank 2 reaches L₁, or in other words, when the water level in the water storage tank 2 reaches an opening end (a lower end) of the mouth part B1 of the container B, the air stops flowing into the container B and supply of the water W to the water storage tank 2 from the container B stops.

Oxygen is extracted from the air by the oxygen generator, and the extracted oxygen is supplied from an oxygen supply part 7 into the lower water storage part 2b of the water storage tank 2 through the supply pipe 72. All the oxygen supplied from the oxygen supplying part 7 into the lower water storage part 2b goes up by buoyancy and is stored in the oxygen space 43 of the partition plate 4, so that the oxygen may form the oxygen layer 43a.

The oxygen in the oxygen space 43 is gradually dissolved in the water in the lower water storage part 2b, intermittently enters into the upper water storage part 2a, and goes up by buoyancy while being formed into air bubbles through the oxygen flow holes 45a of the protrusions 45 of the partition plate 4. Part of the oxygen entering into the upper water storage part 2a is dissolved in the water in the upper water storage part 2a.

The cooling medium is distributed in the cooling pipe 8, and the water in the lower water storage part 2b of the water storage tank 2 is cooled to a predetermined temperature. Ice is formed on the inner surface of the lower water storage part 2b by the above-mentioned cooling operation, and may comes off from the inner surface of the lower water storage part 2b. The ice is prevented from entering into the upper water storage part 2a through the clearance 2c formed between the outer peripheral edge of the partition plate 4 and the inner peripheral surface, facing the same, of the water storage tank 2 by the ice controlling part 41 of the partition plate 4, and is prevented from entering into the oxygen space 43 by the oxygen holding plate 42.

The cooling pipe is not arranged on the upper water storage part 2a of the water storage tank 2, and the water in the upper water storage part 2a is not actively cooled from the outside by a cooling member or the like.

The upper and lower water storage parts 2a, 2b communicate with each other through the clearance 2c formed between the outer peripheral edge of the partition plate 4 and the inner peripheral surface, facing the same, of the water storage tank 2. Only the partition plate 4 exists between the water in the upper water storage part 2a and the water in the lower water storage part 2b.

When the water in the lower water storage part 2b is reduced, the water in the upper water storage part 2a flows into the lower water storage part 2b. However, since the clearance 2c of the water storage tank 2 is as narrow as a few millimeters or less. The water in the lower water storage part 2b and the water in the upper water storage part 2a can not be mixed to each other as the active convective flow of the water in the lower water storage part 2b and the water in the upper water storage part 2a is not generated.

It may happen that the water in the upper water storage part 2a is cooled by the water in the lower water storage part 2b by the intermediary of the partition plate 4. Therefore, in the water cooler body 1, the oxygen space 43 is formed on a lower surface of the partition plate 4, and the oxygen layer 43a is formed in the oxygen space 43, by which the water in the space surrounded by the partition wall 44 of the upper water storage part 2a and the water in the lower water storage part 2b can be thermally isolated from each other by the oxygen layer 43a serving as a heat insulating layer.

Further, the partition wall 44 is erected on the upper surface of the partition plate 4 inside the area where the oxygen space 43 is projected perpendicularly upward with respect to the partition plate 4. The lower end opening part of the fitting part 3b of the container fitting member 3 and an upper end opening part of the connecting pipe section 46 are positioned in the space surrounded by the partition wall 44.

The water in the upper water storage part 2a is taken out from the second faucet 64 through the connecting pipe section 46, the pipe body 54, the discharge pipe 53 and the second connecting pipe 63, as will be mentioned later. The water flowing into the upper end opening part of the connecting pipe section 46 is the water existing in the space surrounded by the partition wall 44, and the water supplied from the inside of the container B through the inside of the fitting part 3b. The former water and the latter water are not directly cooled by the water in the lower water storage part 2b and therefore are not cooled much by the cooled water in the lower water storage part 2b, but are kept at the temperature substantially same as the ambient temperature where the water cooler A is installed.

The water outside the partition wall 44 of the upper water storage part 2a is cooled as the water is in direct contact with the water in the lower water storage part 2b through the clearance 2c connecting the upper and lower water storage parts 2a, 2b with each other, and is further cooled by the water in the lower water storage part 2b by the intermediary of the partition plate 4. However, as mentioned above, since the water in the space surrounded by the partition wall 44 and the water supplied from the container B through the inside of the fitting part 3b preferentially flow into the upper end opening part of the connecting pipe section 46, the water supplied to the second faucet 64 has the temperature close to the ambient temperature where the water cooler A is installed. On the contrary, when the water in the space surrounded by the partition wall 44 and the water supplied from the container B through the inside of the fitting part 3b are warmed excessively by the ambient air in summer, the water outside the partition wall 44 of the upper water storage part 2a also works to cool the water in the space surrounded by the partition wall 44 and the water supplied from the container B through the fitting part 3b to the temperature at which the water is easy to drink.

To be prepared for the case where the water in the space surrounded by the partition wall 44 and the water supplied from the container B through the inside of the fitting part 3b are excessively cooled by the water in the lower water storage part 2b, the heating member 65 is arranged on the second connecting pipe 63 to heat the water flowing or stored in the second connecting pipe 63 so that the water taken out from the second faucet 64 may have the temperature close to the ambient temperature. Since the amount of water heated in the second connecting pipe 63 is very small compared to the amount of water in the upper water storage part 2a, the water in the upper water storage part 2a is not excessively warmed.

When the water stored in the second connecting pipe 63 is heated in particular, the heated water moves up by convection phenomenon, and moves into the upper water storage part 2a through the discharge pipe 53, the pipe body 54 and the connecting pipe section 46. As the heated water moves, additional water flows into the part of the second connecting pipe 63 where the heating member 65 is arranged, and this additional water is also heated by the heating member 65 when the need arises. Thus, by heating the water in the second connecting pipe 63 by the heating member 65 according to necessity, the water in the upper water storage part 2a is prevented from being overcooled and the water having the temperature close to the ambient temperature can be taken out from the second faucet 64.

On the way of moving into the upper water storage part 2a through the discharge pipe 53, the pipe body 54 and the connecting pipe section 46 after being heated by the heating member 65 in the second connecting pipe 63, the water passes inside the lower water storage part 2b, but does not stay at this position. Therefore, the water heated by the heating member 65 moves into the upper water storage part 2a while substantially maintaining the state of being heated, and the water in the lower water storage part 2b is hardly affected by the heated water, too.

In order to take the cooled water out of the water cooler A, the lever 62a is pushed rearward with a cup to closably open the first faucet 62. Then, the cooled water in the lower water storage part 2b flows into the discharge part 5a through the opening part 55c of the cover part 5b of the discharge member 5, and the cooled water flows into the first connecting pipe 61 from the through hole 52a of the discharge part 5a, so that the cooled water can be taken out from the first faucet 62.

After an intended amount of cooled water is taken out from the first faucet 62, the cup is removed from the lever 62a to restore the lever 62a to its former state to close the first faucet 62. By taking out the cooled water in the water storage tank 2 from the first faucet 62, the water in the lower water storage part 2b is reduced, however, as the water is reduced, the water in the upper water storage part 2a flows into the lower water storage part 2b through the clearance 2c.

When the water level in the water storage tank 2, or in other words, the water level of the upper water storage part 2a lowers and the water level in the water storage tank 2 lowers below the level L₁, or to the level L₂ or L₃ for example, which is lower than the level of the opening end or the lower end of the mouth part B1 of the container B, the air is supplied into the container B through the clearance formed between the inner peripheral surface 321b of the container supporting part 32b of the container fitting member 3 and the upper part B2 of the container B. The water flows out of the container B as the air supplied, and the water in the container B is supplied into the upper water storage part 2a through the inside of the fitting part 3b from the distribution hole part 35 of the fitting part 3b.

When much amount of cooled water is taken out from the first faucet 62 and the water level in the water storage tank 2 lowers to the level below the through hole 3c of the supporting part 3a, namely, to the water level L₃, for example, the water in the container B is supplied into the water storage tank 2 through the through hole 3c of the supporting part 3a, too, until the water level in the water storage tank 2 rises to the level higher than the through hole 3c.

When the water level in the water storage tank 2 rises to the level L₁ which is the level equal to that of the opening end or the lower end of the mouth part B1 of the container B, supply of the air into the container B stops and supply of water from the container B into the water storage tank 2 stops.

In order to take out the ambient temperature water, which is not substantially cooled and having the temperature close to the ambient temperature, from the water cooler A, the lever 64a is pushed rearward with the cup to closably open the second faucet 64. Then, first, the ambient temperature water in the space surrounded by the partition wall 44 flows into the connecting pipe section 46 from the upper end opening part of the connecting pipe section 46, flows into the pipe body 54 water-tightly connected to the connecting pipe section 46 and then into the discharge pipe 53 in sequence, so that the water can be taken out from the second faucet 64 through the second connecting pipe 63.

Further, as the ambient temperature water in the space surrounded by the partition wall 44 flows into the connecting pipe section 46 and is taken out from the second faucet 64, the water level in the water storage tank 2, or in other words, the water level in the upper water storage part 2a lowers below level L₁.

Then the water in the container B is supplied into the space surrounded by the partition wall 44 from the distribution hole 35 of the fitting part 3b through the inside of the fitting part 3b, or also through the through hole 3c of the supporting part 3a according to the circumstances, in a manner similar to the case where the cooled water is taken out from the first faucet 62. The water supplied from the inside of the container B flows into the connecting pipe section 46 together with the water already existing in the space surrounded by the partition wall 44, and is taken out from the second faucet 64.

After an intended amount of ambient temperature water is taken out from the second faucet 64, the cup is removed from the lever 64a to restore the lever 64a to its former state to close the second faucet 64. By taking out the ambient temperature water in the water storage tank 2 from the second faucet 64, the water in the upper water storage part 2a is reduced, and the water level in the water storage tank 2, or in other words, the water level of the upper water storage part 2a lowers. Therefore, the water level in the water storage tank 2 falls to the level L₂ (L₃) which is lower than the opening end (the lower end) of the mouth part B1 of the container B.

Then, in a manner similar to that when the cooled water in the lower water storage part 2b is taken out from the first faucet 62, the water flows into the water storage tank 2 from the inside of the container B and into the upper water storage part 2a. When the water level of the upper water storage part reaches L₁, the water supply from the container B into the water storage tank 2 stops.

When all the water in the container B is consumed, the container B is removed after removing the cover member 9, and another container B holding new water which is separately prepared is detachably fitted to the fitting part 3b of the container fitting member 3 in a manner similar to the one mentioned above. Otherwise, the same container B is filled with new water and is detachably fitted to the fitting part 3b of the container fitting member 3 in the similar manner.

As mentioned above, by using the water cooler A, the cooled water is taken out from the first faucet 62 and the ambient temperature water from the second faucet 64 separately. When the cooled water is taken out from the inside of the lower water storage part 2b, the ambient temperature water in the upper water storage part 2a is allowed to flow into the lower water storage part 2b, and additional water is newly supplied from the container B to the inside of the upper water storage part 2a, so that the ambient temperature water in the upper water storage part 2a which is more perishable relative to the cooled water can be actively consumed in the water storage tank 2, whereby the ambient temperature water and the cooled water are respectively kept fresh at intended temperatures.

When the ambient temperature water is taken out from the upper water storage part 2a, additional water is newly supplied from the container B into the upper water storage part 2a so that fresh water can be supplied from the container B into the upper water storage part 2a.

Thus, since the water is sufficiently supplied from the single container B to the upper and lower water storage parts 2a, 2b of the water storage tank 2 of the water cooler A, the water cooler can be smaller. In addition, since it is enough to maintain only the single container B for supplying the water into the water storage tank 2 of the water cooler A, the maintenance is facilitated.

We claim:

1. A water cooler comprising:
a water cooler body,
a water storage tank arranged in the water cooler body, and
a container fitting member arranged on an upper end of the water storage tank for detachably fitting the container so that the water in the container can be supplied into the water storage tank, wherein the water storage tank is divided into upper and lower water storage parts by a partition plate so that the water in the upper water storage part and the water in the lower water storage part can be taken out separately, in which the upper and lower water storage parts are partially connected and communicated with each other, and the lower water storage part is provided with a cooling device so that the water in the lower water storage part can be cooled.

2. The water cooler as claimed in claim 1 further comprising an ice controlling part arranged to extend downward on an outer peripheral edge part of the partition plate.

3. The water cooler as claimed in claim 1 further comprising:
an oxygen supplying part arranged at a lower part of the water storage tank to supply oxygen into the water storage tank, and
an oxygen holding plate having a cylindrical shape and integrally arranged on a lower surface of the partition plate,
wherein the part surrounded by the oxygen holding plate and the partition plate is formed to serve as an oxygen space for holding the oxygen supplied from the oxygen supplying part, and an oxygen flow hole connecting the upper and lower water storage parts with each other is formed in the partition plate part forming the oxygen space so that the oxygen in the oxygen space can be supplied to the upper water storage part through the oxygen flow hole.

4. The water cooler as claimed in claim 3 further comprising:
a connecting pipe section arranged in a manner of integrating with the partition plate and vertically penetrating the same, and
a partition wall having a cylindrical shape and erected on an upper surface of the partition plate part forming the oxygen space in a state of surrounding the connecting pipe section, in which the water in the container fitted to the container fitting member is supplied into the space surrounded by the partition wall, and an oxygen flow hole is formed in the partition plate part surrounded by the partition wall so that the water in the upper water storage part can be taken out through the connecting pipe section.

5. The water cooler as claimed in claim 1 further comprising:
a discharge member including a discharge part having a bottomed cylindrical shape and arranged on a bottom of the water storage tank in an integrating manner,
a discharge pipe penetrating the bottom of the discharge part, in which the inside of the discharge part is connected to a first faucet by the intermediary of the first connecting pipe and a lower end part of the discharge pipe is connected to the second faucet by the intermediary of the second connecting pipe, and
a connecting pipe section integrally provided to the partition plate, communicating with the upper and lower water storage parts, and connected to the discharge pipe of the discharge member at a lower end thereof.

6. The water cooler as claimed in claim 1, wherein the container fitting member comprises a supporting part having a bottomed cylindrical shape, and a fitting part arranged in a manner of projecting upward from a bottom of the supporting part for detachably fitting a mouth part of the container, in which a space communicating with the water storage tank is formed in the fitting part, and the inside of the supporting part and the inside of the water storage tank are communicated with each other via the space.

7. The water cooler as claimed in claim 5 further comprising a heating device arranged on the second connecting pipe.
